(19) United States
(12) Patent Application Publication
(10) Pub. No.: US 2015/0227932 A1
(43) Pub. Date: Aug. 13, 2015

(54) ISSUING AND STORING OF PAYMENT CREDENTIALS

(71) Applicant: Visa International Service Association, San Francisco, CA (US)

(72) Inventors: Horatio Nelson Huxham, Cape Town (ZA); Alan Joseph O'Regan, Cape Town (ZA); Hough Arie Van Wyk, Cape Town (ZA); Tara Anne Moss, Cape Town (ZA)

(21) Appl. No.: 14/418,866

(22) PCT Filed: Jul. 29, 2013
(86) PCT No.: PCT/IB2013/056226

§ 371 Date: Jan. 30, 2015

(30) Foreign Application Priority Data
Aug. 2, 2012 (ZA) 2012/05827

(51) Int. Cl. G06Q 20/40; G06Q 20/38

(52) U.S. Cl. CPC G06Q 20/4014; G06Q 20/38215; G06Q 20/3821

(57) ABSTRACT

A system and method of issuing payment credentials to a consumer is disclosed. A payment processing network sends payment credentials and an identifier of a consumer to whom the payment credentials belong to a secure gateway. The secure gateway encrypts or zone translates the payment credentials and sends them to a mobile device of the consumer through a secure communication channel. The mobile device includes a hardware security module (HSM) which stores the payment credentials to be used for subsequent financial transactions by the consumer. Multiple sets of payment credentials may be stored on the HSM, corresponding to multiple payment accounts belonging to the consumer.

### CROSS-REFERENCES TO RELATED APPLICATIONS

This application claims priority from South African Provisional Patent Application No. 2012/05827 filed on 2 Aug. 2012 entitled “Issuing and Storing of Payment Credentials”.

### BACKGROUND TO THE INVENTION

Credit or debit cards store payment credentials in various ways depending on their implementation. In some cases, a magnetic stripe on a credit or debit card stores so-called track 1 and track 2 data. Track 1 and track 2 data includes the Primary Account Number (PAN) of the card, expiry date and security code which may also be printed on the surface of the card, as well as data which is not printed on the card such as a service code. In the EMV (Europay, MasterCard and Visa) standard, track 1 and track 2 data is stored on a secure microchip embedded in the payment card which is access-controlled by means of a password.

In card-not-present transactions, a consumer may provide the PAN, expiry date and security code that are printed on the face of the credit/debit card to an e-commerce system. The consumer is not, however, able to provide the full track 1 and track 2 data (such as the additional service code) which is only stored on the magnetic stripe or EMV chip and which distinguishes card-not-present transactions from card-present transactions. Card-not-present transactions are typically assigned a higher fraud risk profile than card-present transactions.

Issuing of credit or debit cards to consumers may be a relatively expensive and slow process, and involves an issuing bank giving an instruction to a card manufacturer to manufacture a card for a consumer, arranging for the safe delivery of the card to the consumer and the activation of the card after delivery. From the consumer's perspective, acquiring an array of different payment cards can make handling, carrying and safekeeping of all the cards problematic.

Systems exist in which some payment credentials are stored in a software application on a mobile phone, commonly referred to as a digital wallet system or mobile wallet system. However, widely adopted payment card industry standards such as the PCI DSS (Payment Card Industry Data Security Standard), prohibits full track 1 and track 2 data from being stored in software due to the risk of theft or fraud in respect of such data. Digital wallet systems are thus only able to store card details for the purpose of card-not-present transactions, not card-present transactions.

Embodiments of the invention aim to address these and other problems.

### BRIEF SUMMARY OF THE INVENTION

In accordance with the invention there is provided a method for issuing payment credentials to a consumer, the method comprising: at a secure gateway, receiving payment credentials and a consumer identifier of a specific consumer to whom the payment credentials belong, encrypting or zone translating the payment credentials, communicating through a secure communication channel with a mobile device of the specific consumer to whom the payment credentials belong, the mobile device having a hardware security module (HSM) and the mobile device being identified by means of the consumer identifier, and forwarding the encrypted payment credentials through the secure communication channel to the mobile device, wherein the mobile device stores the encrypted payment credentials on the HSM of the mobile device.

Further features of the invention provide for the step of communicating through a secure communication channel with a mobile device of the specific consumer to whom the payment credentials belong to include the step of matching the consumer identifier with a stored identifier of the HSM of the mobile device.

Still further features of the invention provide for the secure communication channel to be established with the mobile device using a predetermined sequence of network messages that are received at the HSM; alternatively by means of the secure gateway presenting the mobile device with a cryptographic key challenge.

The communication session may be provided using Short Message Service (SMS) protocol, Unstructured Supplementary Service Data (USSD) protocol, one or more data communication messages or one or more voice call communication messages; and the mobile device may be configured to store multiple sets of payment credentials on the HSM corresponding to multiple payment accounts belonging to the consumer.

Further features of the invention provide for the payment credentials to include the full payment credentials necessary to establish a card-present type transaction; and for the consumer using the mobile device to be capable of authorizing the transfer of the payment credentials to a second mobile device that includes an HSM, so that a different person is able to use the payment credentials on the consumer's behalf.

The payment credentials may be transferred using secure communications through a secure communication channel directly between the mobile device of the consumer and the second mobile device; alternatively, the payment credentials may be transferred to the second mobile device via the secure gateway through a secure communication channel between the second mobile device and the secure gateway.

The secure communications may include sending secure communications using a communication protocol selected from a group consisting of SMS protocol, USSD protocol, Near Field Communication (NFC) protocol, Radio Frequency (RF) communications protocol, and Near Sound Communication (NSC) protocol.

The invention extends to a system for issuing payment credentials to a consumer, the system comprising: a secure gateway and a mobile device of a consumer to whom payment credentials belong, the mobile device having a hardware security module (HSM) and the mobile device being identified by means of a consumer identifier, wherein the secure gateway is configured to: receive the payment credentials and the consumer identifier of the specific consumer to whom the payment credentials belong, encrypt or zone translate the payment credentials, establish a communication session through a secure communication channel with the mobile device of the specific consumer to whom the payment credentials belong, and forward the encrypted payment credentials through the secure communication channel to the mobile device, wherein the mobile device stores the encrypted payment credentials on the HSM of the mobile device.

Further features of the invention provide for the HSM to be a cryptographic expansion device attached to a communication component of the mobile device. The communication component may be a Subscriber Identity Module (SIM) card, the cryptographic expansion device may be in the form of a label that is attached to the SIM card, and the mobile device may be a mobile phone.

In order that the invention may be more fully understood, implementations thereof will now be described with reference to the accompanying drawings.

### BRIEF DESCRIPTION OF THE DRAWINGS

FIG. 1 illustrates a system for issuing payment credentials to a consumer according to an embodiment of the invention;

FIG. 2 illustrates a flow diagram of a method for issuing payment credentials to a consumer according to an embodiment of the invention;

FIG. 3 illustrates a mobile device which includes a hardware security module according to an embodiment the invention;

FIG. 4 illustrates a hardware security module in the form of a cryptographic expansion device;

FIG. 5 is a block diagram of the hardware components of the cryptographic expansion device of FIG. 4;

FIG. 6 is a block diagram of the functional components of the cryptographic expansion device of FIG. 4;

FIG. 7 is a flow diagram of a method of transferring payment credentials to a second mobile device that includes an HSM;

FIG. 8 illustrates a diagram showing the process of performing a secure operation in a mobile device equipped with a cryptographic expansion device, according to one embodiment of the invention;

FIG. 9 illustrates a diagram showing the process of setting up a secure communication channel between devices using a cryptographic expansion device, according to one embodiment of the invention;

FIG. 10 illustrates a flow diagram of performing a secure operation with a cryptographic expansion device, according to one embodiment of the invention;

FIG. 11 is a block diagram of the functional components of a computer system used in the invention; and

FIG. 12 is a block diagram of the functional components of a mobile device used in the invention.

### DETAILED DESCRIPTION WITH REFERENCE TO THE DRAWINGS

A system and method for issuing payment credentials to a consumer is provided. A payment processing network sends payment credentials and an identifier of a consumer to whom the payment credentials belong to a secure gateway. The secure gateway encrypts or zone translates the payment credentials and sends them to a mobile device of the consumer through a secure communication channel. The mobile device includes a hardware security module (HSM) which stores the encrypted payment credentials to be used for subsequent financial transactions by the consumer. Multiple sets of payment credentials may be stored on the HSM, corresponding to multiple payment accounts belonging to the consumer.

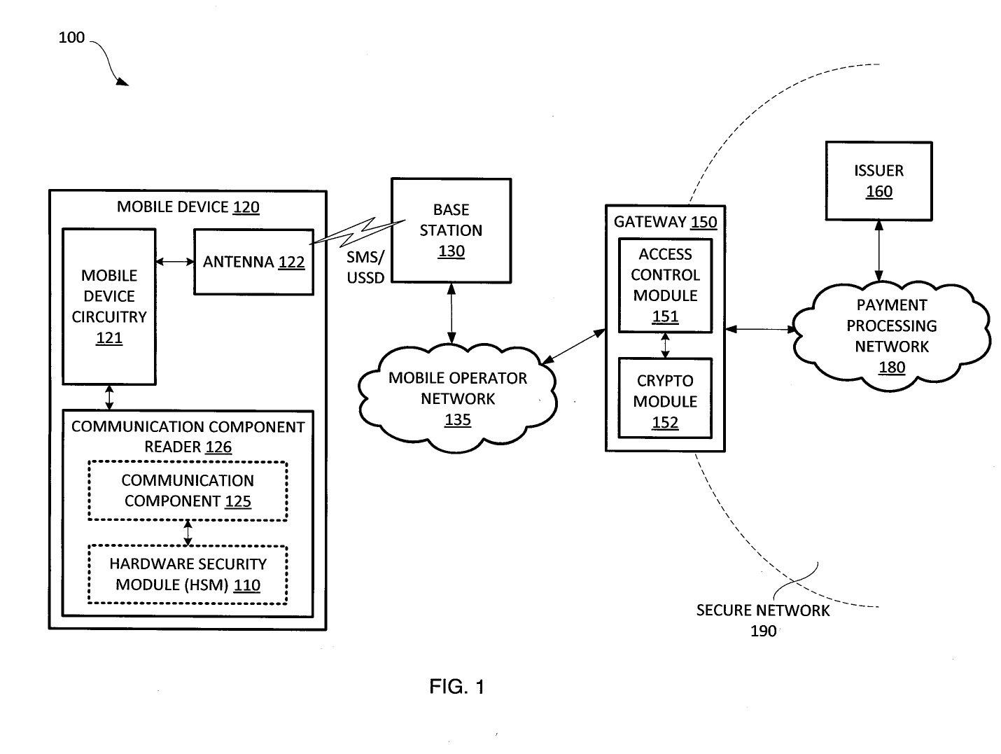

FIG. 1 illustrates an embodiment of a system (100) for issuing payment credentials to a consumer according to the invention. The system (100) includes a mobile device (120) that can communicate with a base station (130) associated with a mobile operator (e.g., a cellular or wireless provider) providing cellular or wireless service to the mobile device (120), and a secure gateway (150) that interfaces between a secure network (190) and external networks. The secure network (190) is a network that implements a high level of security standards for data transmission and storage such as those in compliance with the PCI DSS (Payment Card Industry Data Security Standard). The secure network (190) includes a payment processing network (180) and an issuer (160) associated with a financial account (e.g., a bank account, or credit card account) of a consumer that uses the mobile device (120).

The payment processing network (180) may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. Furthermore, the payment processing network (180) may include one or more servers and may use any suitable wired or wireless network, including the Internet.

The base station (130) can relay communications between the mobile device (120) and the secure gateway (150) through a mobile operator network (135). These communications can include Short Message Service (SMS) and/or Unstructured Supplementary Service Data (USSD) messages and/or other types of communications (e.g., voice, data) that are supported by the mobile operator between the mobile device (120) and the secure gateway (150) through the mobile operator network (135). Data communication may be enabled by a software application installed on the mobile device (120), such as a web browser or dedicated mobile software application installed thereon. The mobile operator network (135) may include any number of network entities and network devices that can provide both wired and wireless connectivity to exchange communications between the base station (130) and the secure gateway (150). For example, the mobile operator network (135) may include a Short Message Service Center (SMSC) to process SMS messages from the mobile device (120), and relay the SMS messages to the secure gateway (150) through a SMSC connector network device.

According to embodiments of the invention, the secure gateway (150) can prevent unauthorized access to the secure network (190) from unauthorized devices on external networks such as the mobile operator network (135). The secure gateway (150) can communicate with a server of the issuer (160) through the payment processing network (180). In some embodiments, the secure gateway (150) can communicate directly with a server of the issuer (160), bypassing the payment processing network (180).

The secure gateway (150) includes an access control module (151) and a cryptographic module (152). The access control module (151) includes a set of access rules that can be used to determine which devices of an external network are authorized to communicate with the secure network (190), and can establish secure communication channels through the mobile operator network (135), for example, to send and receive encrypted messages with the mobile device (120). The cryptographic module (152) can perform cryptographic operations such as encryption and decryption operations on user messages sent to and from the mobile device (120). In some embodiments, the cryptographic module (152) can also re-zone (zone translate) or re-encrypt user messages from external networks before forwarding the user messages onto the secure network (190), for example, to conform user messages from external networks to the security protocols of the secure network (190) or other necessary security standards.

The mobile device (120) can be any form of portable communication device that can send and receive SMS and/or USSD messages or other types of communications, such as data communications, with a cellular communication system such as Global System for Mobile communications (GSM). For example, the mobile device (120) can be a cellular or wireless phone, a smartphone, a tablet computer, a personal digital assistant (PDA), a pager, a portable computer, or the like. The mobile device (120) includes mobile device circuitry (121), a communication component reader (126), and an antenna (122). The mobile device circuitry (121) includes any suitable hardware and/or software installed on the hardware to carry out the functionalities of the mobile device (120), such as a user interface (display, touchscreen, buttons, speaker, microphone, etc.) to interact with a user of the mobile device (120), and one or more processors coupled to machine readable storage medium that stores machine executable code that can be executed by the processor to perform the functionalities of the mobile device (120). The antenna (122) is used by the mobile device circuitry (121) to send and receive cellular communications such as SMS, USSD, and/or other types of communications (e.g., voice call communications, data communications) with the base station (130).

The communication component reader (126) can be a communication card reader such as a Subscriber Identity Module (SIM) card reader that can read and write information and access application programs on a communication component (125). The communication component (125) can be a user-removable communication component such as a communication card (e.g., a SIM card), or other types of user-removable communication components of a mobile device such as a memory card that stores information and/or application programs that the mobile device (120) can use to send and receive communications.

A conventional mobile device does not typically include an integrated HSM. Thus, according to embodiments of the invention, a hardware security module (HSM) (110) can be attached to the communication component (125) of the mobile device (120) to enable the mobile device to perform cryptographic operations on communications sent to and from the mobile device (120). The HSM (110) includes embedded processors and storage capabilities that can be used to implement a Federal Information Processing Standards (FIPS) compliant hardware security module to provide the mobile device (120) with the set of security features and functions as found in industry-standard HSMs. When used with the mobile device (120), the HSM (110) enables the mobile device (120) to send and receive end-to-end encrypted communications with the secure gateway (150).

It will be appreciated that the HSM (110) need not be attached to the communication component (125) but could, in other embodiments, be integrated in the mobile device circuitry or be electrically coupled to the mobile device in any other suitable manner.

It should be noted that the mobile device with an HSM in accordance with embodiments of the invention is different from an electronic device that may solely use software to encrypt communications between an electronic device and a target device or system. An electronic device that solely uses software to encrypt communications may comply with only a security level 1 of the Federal Information Processing Standard 140-2 (FIPS 140-2), which provides only a minimum level of security to protect sensitive information. In contrast, the HSM within a mobile device according to embodiments of the invention is compliant with at least a security level 2 of the FIPS 140-2 standard. More preferably, the HSM within the electronic device in embodiments of the invention is compliant with security level 3 or level 4 of FIPS 140-2.

The HSM in embodiments of the invention uses hardware to encrypt data instead of solely performing the encryption in software. The HSM provides enhanced protection over software encryption technologies. For example, the HSM provides secure key management to generate cryptographic keys, sets the capabilities and security limits of keys, implements key backup and recovery, prepares keys for storage and performs key revocation and destruction. In some embodiments, the HSM is implemented as a dual processor device that includes a secure processor with storage and a public processor with storage. The HSM may also include a physical or logical separation between interfaces that are used to communicate critical security parameters and other interfaces that are used to communicate other data. The HSM can also provide a tamper-proof mechanism that provides a high risk of destroying the HSM and the cryptographic keys stored therein, if any attempt is made to remove or externally access the HSM.

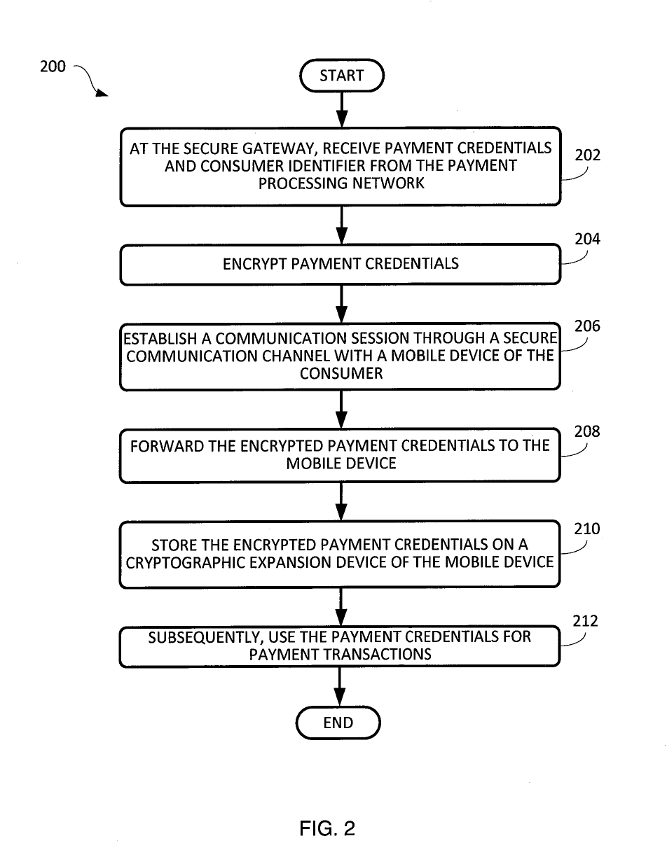

The system of FIG. 1 can be used to securely issue payment credentials to a consumer according to the flow diagram (200) shown in FIG. 2. At a first stage (202), the secure gateway (150) receives payment credentials and a consumer identifier of the consumer to whom the payment credentials belong from the payment processing network (180). The payment credentials may be generated by the payment processing network (180) or, alternatively, by the issuer (160) and transferred from the issuer (160) to the payment processing network (180) for providing the payment credentials to a consumer. It should be appreciated that, in other embodiments, the payment credentials may be transmitted directly from the issuer (160) to the secure gateway (150). Typically, a consumer will have undergone an enrolment process in which a unique identifier will have been created by the payment processing network, the identifier being associated uniquely with a particular mobile device's HSM. To enable unique identification of the HSM, the HSM, in a preferred embodiment, stores a unique token which enables it to be verified. During the enrolment process, this token is associated with the unique identifier.

At a next stage (204), the secure gateway (150) encrypts the payment credentials by using the cryptographic module (152). The cryptographic module (152) can store and execute various encryption algorithms such as Advance Encryption Standard (AES), Data Encryption Standard (DES), Triple Data Encryption Standard/Algorithm (TDES/TDEA), Blowfish, Serpent, Twofish, International Data Encryption Algorithm (IDEA), Rivest, Shamir, & Adleman (RSA), Digital Signature Algorithm (DSA), Tiny Encryption Algorithm (TEA), extended TEA (XTEA), and/or other suitable cryptographic or encryption algorithms. In response to encryption requests from the access control module (151), the cryptographic module (152) can look up the requested encryption algorithm, obtain any necessary cryptographic keys from a cryptographic key storage within the cryptographic module (152), perform the encryption, and reply to the access control module (151) with the encrypted data. Alternatively, and in the event that the payment credentials received at the secure gateway are already encrypted, the secure gateway is configured to zone-translate the payment credentials as previously described.

At a next stage (206), the secure gateway (150) then establishes a communication session through a secure communication channel with the HSM (110) of the mobile device (120) uniquely identified by the consumer identifier. In embodiments of the invention, a secure communication channel is established by means of the secure gateway (150) transmitting a number of messages of a predetermined sequence and with predetermined port identifiers to the mobile device (120). The HSM (110) compares the predetermined sequence of messages with access rules pre-programmed into the HSM (110) that the HSM (110) expects to receive from the secure gateway (150). If the HSM (110) determines that the entire predetermined sequence of messages has been received, it sends a response message to the secure gateway (150) in the form of a synchronize-acknowledgement message. Then, the HSM (110) authenticates the secure gateway (150) to be authorized to communicate with the HSM (110). It will be appreciated that the predetermined sequence of messages will be selected so as to be sufficiently complex to render the likelihood essentially negligible of obtaining the correct sequence using brute force techniques like port scanning.

In some embodiments, as an alternative or in addition to the predetermined sequence of messages, before the secure communication channel is established, the secure gateway (150) sends a cryptographic key challenge to the mobile device (120). The cryptographic key challenge can include a random number and a request for the HSM (110) of the mobile device (120) to encrypt the random number using a cryptographic key that is only known to authorized HSMs. The cryptographic key can be a symmetric key or an asymmetric key preloaded in the HSM (110). The HSM (110) encrypts the received random number using the preloaded cryptographic key and sends the result back to the secure gateway (150). The secure gateway (150) decrypts the result and compares it to the random number sent to the secure gateway. If the results match, then the secure communication channel is established. These two methods used for establishing a secure communication channel will be described in greater detail with reference to FIG. 9.

At a next stage (208), the encrypted payment credentials are forwarded to the mobile device (120) through the secure communication channel. At a next stage (210), the encrypted payment credentials are then stored on the HSM (110) in a secure memory area of the HSM (110), as will be described below.

A software application resident on the mobile device (120) is capable of communicating with the HSM (110) to enable the consumer to select a set of payment credentials, for example by tapping on an image of a credit/debit card associated with those payment credentials on a display interface of the mobile device, and to set a specific set of payment credentials as the default payment credentials. At a next stage (212), the consumer can use the payment credentials in this manner to conduct payment transactions, for example by presenting the encrypted payment credentials to an acceptance terminal which is able to decrypt them. The payment credentials can be presented to an acceptance terminal in various ways, including by using a near field communication (NFC) module of the mobile device, by Wi-Fi, Near Sound Communication (NSC), Bluetooth, Quick Response (QR) code displays. It will be appreciated that any other suitable way of transferring payment credentials from the HSM (110) to an acceptance terminal may be employed.

It should be appreciated that the stored payment credentials may enable the consumer to conduct both acceptance terminal transactions and e-commerce transactions. In the case of e-commerce transactions, the payment credentials may be transmitted directly to a merchant, directly to a merchant acquirer, or to the secure network, in order to initiate, process or complete an e-commerce transaction.

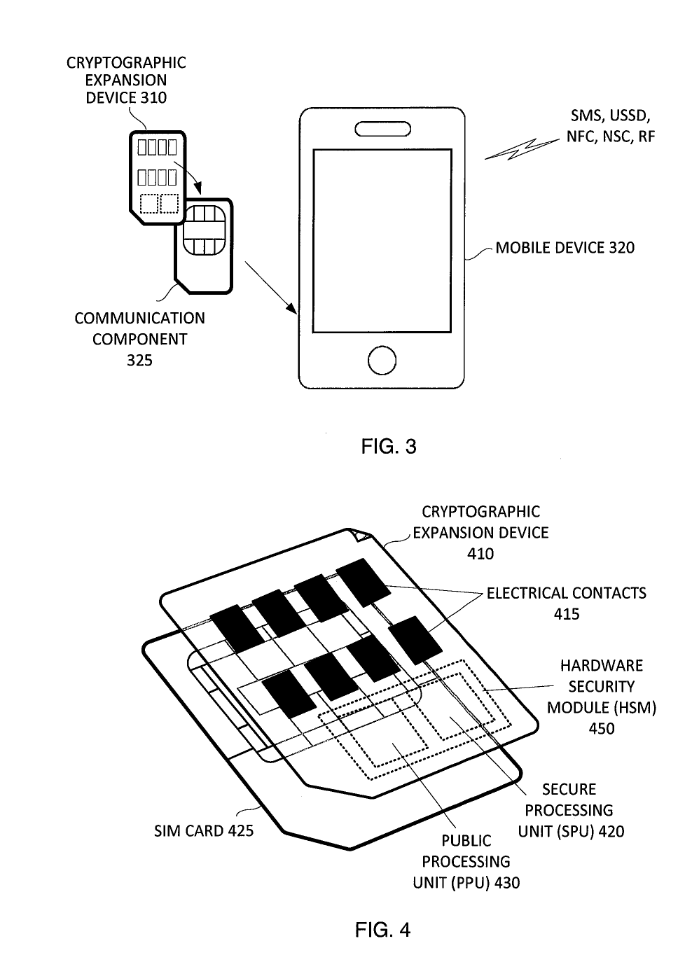

FIG. 3 illustrates a mobile device (320) according to one embodiment. The mobile device (320) includes an HSM in the form of a cryptographic expansion device (310) attached to a user-removable communication component (325) installed in the mobile device. In this embodiment, the cryptographic expansion device (310) is in the form of a label, the communication component (325) is a SIM card, and the mobile device (320) is a mobile phone. When the label is connected to the SIM card, the capability of the mobile device (320) is extended to enable the mobile device (320) to perform cryptographic operations as previously described. It will be appreciated that the cryptographic expansion device (310) may provide the mobile device (320) with the cryptographic capabilities without requiring any modifications to the internal hardware and/or software of the mobile device (320) or that of the communication component (325).

FIG. 4 illustrates an exemplary cryptographic expansion device (410) in the form of a flexible adhesive circuit structure that connects to a SIM card (425). According to this embodiment, the cryptographic expansion device (410) is a circuit board with integrated circuits implementing a hardware security module (HSM) (450) therein. The HSM (450) includes a public processing unit (PPU) (430) and a secure processing unit (SPU) (420) which are logically and physically separate from each other. The cryptographic expansion device (410) includes a set of electrical contacts (415) disposed on an upper side of the device and which interface with a SIM card reader, and a set of contacts (not shown) disposed on the bottom side of the device which interface with the SIM card (425). Once adhesively connected to the SIM card (425), the cryptographic expansion device (410) may, in some embodiments, be rendered unusable if an attempt is made to separate it from the SIM card (425), for example by means of contact pads or interconnections ripping apart when separated.

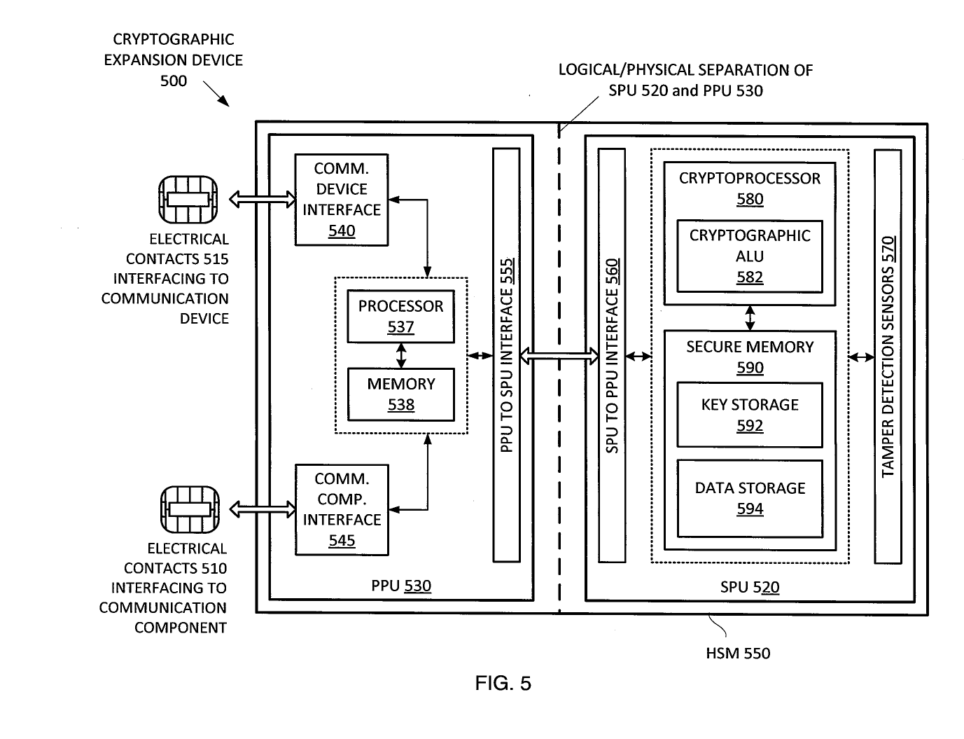

FIG. 5 shows a block diagram illustrating the hardware components of a cryptographic expansion device (500) according to one embodiment. The cryptographic expansion device (500) includes an HSM (550) having a public processing unit (PPU) (530) and a secure processing unit (SPU) (520) coupled to the PPU (530). It should be noted that although the SPU (520) is coupled to the PPU (530), the cryptographic expansion device (500) provides a logical and/or physical separation between the SPU (520) and the PPU (530). A “physical separation” refers to some physical boundary between the SPU (520) and the PPU (530). For example, the SPU (520) and the PPU (530) can be implemented with and manufactured as separate semiconductor dies or separately packaged semiconductor chips, and the physical boundary of the dies or chips can serve as the physical separation. A “logical separation” refers to the separation of the communication interface and storage memory between the SPU (520) and the PPU (530). As shown in FIG. 5, the SPU (520) has its own communication interfaces (540, 545, 555) which are separate from a communication interface (560) of the SPU (520). The PPU (530) also has its own memory (538), which is separate from a secure memory (590) of the SPU (520). As will be explained below, the logical and/or physical separation provided between the SPU (520) and the PPU (530) creates a division in hardware roles to protect the SPU (520) and the contents stored in the secure memory (590) from unauthorized accesses.

According to some embodiments, the PPU (530) includes a processor (537), a memory (538), a communication device interface (540), a communication component interface (545), and a PPU-to-SPU interface (555). The processor (537) can be implemented as one or more processors or controllers. The memory (538) is coupled to the processor (537), and provides storage to store data and executable code that when executed by the processor (537), causes the processor (537) to run an operating system (OS) and/or applications that can be complaint with PCI DSS (Payment Card Industry Data Security Standard) and International Organization for Standardization (ISO) standards to manage the functionality and operations of the cryptographic expansion device (500), and to process the exchange of information between the various interfaces of the PPU (530).

The communication device interface (540) is coupled to electrical contacts (515) that interface with a communication device such as a mobile device (e.g., a mobile phone), and provides a set of signals that can include a clock signal and one or more data input/output (I/O) signals to send and receive commands and information between the PPU (530) and the communication device. The communication component interface (545) is coupled to electrical contacts (510) that interfaces to a communication component such as a communication card (e.g., a SIM card), and provides a set of signals that can include a clock signal and one or more data input/output (I/O) signals to send and receive commands and information between the PPU (530) and the communication component. The PPU-to-SPU interface (550) is coupled to the SPU (520), and provides a set of signals that can include a clock signal and one or more data input/output (I/O) signals to send commands and information such as encryption and decryption requests to the SPU (520), and to receive commands and information such as encryption and decryption results from the SPU (520). Because of the logical and physical separation between the SPU (520) and the PPU (530), the SPU (520) is exposed to the PPU (530) only, and is not accessible to the communication device or to the communication component, except through the PPU (530). Hence, the PPU (530) can serve as a firewall or a gatekeeper to ensure unauthorized or unwanted communications such as hacking attempts are not sent to the SPU (520).

According to some embodiments, the SPU (520) includes a cryptoprocessor (580), a secure memory (590), and an SPU-to-PPU interface (560). The SPU (520) can also include tamper detection sensors (570). As mentioned above, the SPU (520) is accessible from the PPU (530) only, and receives commands and information from the PPU (530) through the SPU-to-PPU interface (560). The SPU-to-PPU interface (560) provides a set of signals that can include a clock signal and one or more data input/output (I/O) signals coupled to the PPU-to-SPU interface (555) that the SPU (520) can use to communicate with the PPU (530). In some embodiments, the SPU (520) will only respond to encryption and decryption requests to perform cryptographic operations from the PPU (530) received through the SPU-to-PPU interface (560).

The cryptoprocessor (580) can be implemented as one or more cryptographic processors. A cryptographic processor is different from a general purpose processor in that a cryptographic processor includes dedicated circuitry and hardware such as one or more cryptographic arithmetic logic units (ALUs) (582) that are optimized to perform computational intensive cryptographic functions. The cryptographic ALUs (582) can include optimized pipelines and widen data buses to enable the cryptoprocessor (580) to perform cryptographic operations faster and more efficiently than general purpose processors.

The secure memory (590) is coupled to the cryptoprocessor (580), and can be partitioned into a cryptographic key storage (592) and a data storage (594). The data storage (594) can be read and written by the cryptoprocessor (580), and provides storage memory to store user data such as data that are received on the SPU-to-PPU interface (560) from the PPU (530), and encryption and decryption results that are sent to the PPU (530) through the SPU-to-PPU interface (560). The key storage (592) can be read-only to the cryptoprocessor (580), and is used to store cryptographic keys and encryption algorithms. The cryptographic keys and algorithms stored in the key storage (592) are provisioned by the manufacturer during manufacturing of the cryptographic expansion device (500), and cannot be altered by an external source without a master key that is only known to the manufacturer and/or authorized parties who are authorized to provision the cryptographic expansion device (500) such as a mobile network operator or a wireless service provider. In some embodiments, the content of the key storage (592) is never transmitted outside of the SPU (520), and is inaccessible by the PPU (530). The cryptographic keys and algorithms stored in the key storage (592) can be provisioned to perform various encryption standards and protocols including but not limited to Data Encryption Standard (DES), Triple Data Encryption Standard/Algorithm (TDES/TDEA), DES-X, Secure Socket Layer (SSL), Advanced Encryption Standard (AES), Blowfish, Serpent, Twofish, Threefish, International Data Encryption Algorithm (IDEA), Rivest, Shamir, & Adleman (RSA), Digital Signature Algorithm (DSA), Tiny Encryption Algorithm (TEA), extended TEA (XTEA), and/or other suitable encryption algorithms or protocols.

In some embodiments, the tamper detection sensors (570) are included to detect external attempts to tamper with the cryptographic expansion device (500). For example, the tamper detection sensors (570) may include temperature sensors to detect temperatures that may be indicative of someone attempting to desolder components of the cryptographic expansion device (500), and/or mechanical sensors to sense structural changes to the cryptographic expansion device (500) that may be indicative of someone attempting to dissect or cut open the cryptographic expansion device (500). The tamper detection sensors (570) may also include electrical sensors to sense certain voltage, current, or impedance changes to the circuitry of the cryptographic expansion device (500) that may be indicative of someone attempting to probe the components of the cryptographic expansion device (500), and/or electromagnetic sensors to sense certain radiation such as X-rays that may be indicative of someone attempting to examine the cryptographic expansion device (500). In some embodiments, the tamper detection sensors (570) may include circuitry that can erase and wipe out the contents of the secure memory (590) to render the SPU (520) and/or the cryptographic expansion device (500) unusable in response to detecting an attempt to tamper with the cryptographic expansion device (500). The cryptographic expansion device (500) can also be configured with organic or soluble interconnects that can be dissolved by a solvent released by the tamper detection sensors (570) in response to detecting an attempt to tamper with the cryptographic expansion device (500).

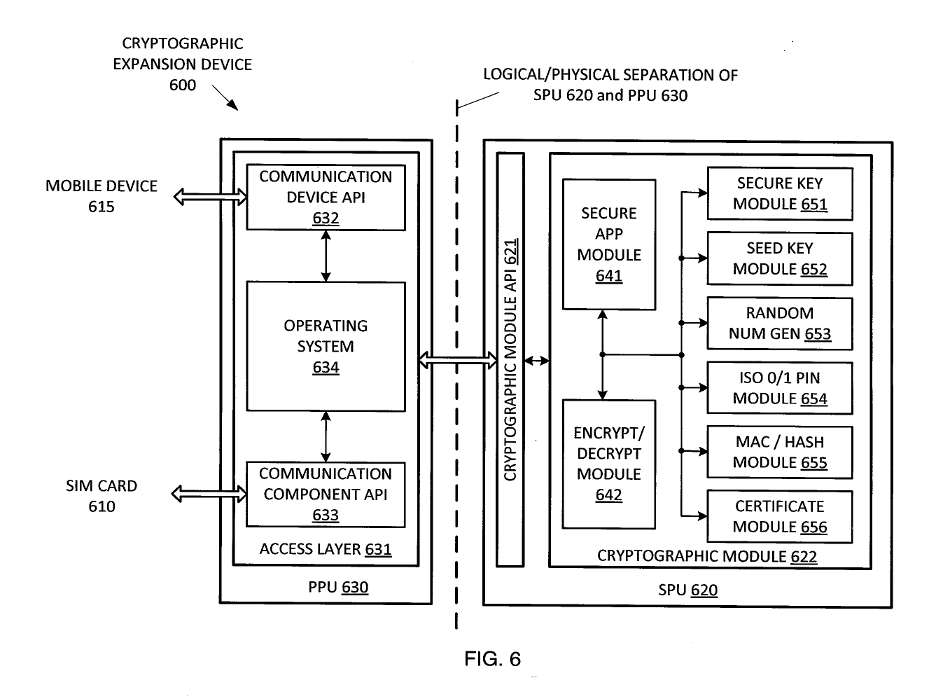

FIG. 6 illustrates the functional modules of a cryptographic expansion device (600) according to one embodiment, where the cryptographic expansion device (600) is attached to a SIM card (610) of a mobile device (615). The PPU (630) includes an operating system (OS) (634), a communication device application programming interface (API) (632), and a communication component API (633). The OS (634), the communication device API (632), and the communication component API (633) together form an access layer (631), which represents the publicly accessible portion of the cryptographic expansion device (600). By “publicly accessible”, it is meant that any device or components of the mobile device (615) that can communicate directly with the SIM card (610) or with a SIM card reader of the mobile device (615) would be able to send and receive commands and information to and from the access layer (631).

The communication device API (632) provides a programming interface to translate commands and information received from the mobile device (615) into instructions and data that the OS (634) can process and execute, and vice versa. For example, the communication device API (632) may translate commands from the mobile device (615) according to a mobile phone's SIM toolkit protocol into instructions and data that the OS (634) can process and execute to respond to the commands, and vice versa. The communication component API (633) provides a programming interface to translate commands and information received from the SIM card (610) into instructions and data that the OS (634) can process and execute, and vice versa. For example, the communication component API (633) may translate commands from the SIM card (610) according to the SIM card's SIM toolkit protocol into instructions and data that the OS (634) can process and execute to respond to the commands, and vice versa.

The OS (634) manages the functionality and operations of the cryptographic expansion device (600), and responds to commands and information from the mobile device (615) and/or the SIM card (610). The functionality and operations of the cryptographic expansion device (600) that the OS (634) can manage includes responding to user input received on the mobile device (615) that relates to cryptographic operations, masking PIN entries on a user interface of the mobile device (615), creating ISO PIN blocks in the SPU (620), sending encryption and decryption requests to the SPU (620) for secure communications sent to and from a communication interface of the mobile device (615), sending requests to the SPU (620) to create or verify MAC or hash values for messages or portions of messages sent to and from a communication interface of the mobile device (615), providing certificates for HTTPS applications, storing encrypted communications history, providing basic encryption to external applications, and managing commands and information exchange through the various interfaces such as passing through commands and information between the mobile device (615) to the SIM card (610).

For example, in response to encryption and decryption commands received from the mobile device (615) on the communication device API (632), the OS (634) can send encryption and decryption requests and associated data to the SPU (620). The OS (634) may access and process information stored in the SIM card (610) in response to a command to perform as such received from the mobile device (615) on the communication device API (632). The OS (634) can also access information stored in the SIM card (610) and forward the information to the SPU (620) in response to encryption and decryption commands involving such information. The OS (634) can forward encryption and decryption results from the SPU (620) to the mobile device (615) and/or the SIM card (610). The OS (634) can also issue commands to the mobile device (615) and/or the SIM card (610), for example, commands to request the mobile device (615) to send a secure communication with data encrypted by the SPU (620).

The SPU (620) of the cryptographic expansion device (600) can be implemented with a cryptoprocessor coupled to a memory. The SPU (620) of the cryptographic expansion device (600) includes a cryptographic module API (621) and a cryptographic module (622). The cryptographic module API (621) provides a programming interface to translate commands and information received from the OS (634) into instructions and data that the cryptographic module (622) can process and execute, and vice versa. For example, the OS (634) may send an encryption/decryption request to the SPU (620), and the cryptographic module API (631) may translate the encryption/decryption request into an encryption/decryption instruction for the cryptographic module (622) to execute. In some embodiments, the cryptographic module API (621) may also include, in the translated encryption/decryption instruction, which particular encryption algorithm the cryptographic module (622) should use based on the particular application that is requesting the cryptographic operation.

According to various embodiments, the cryptographic module (622) includes a secure application module (641), an encryption/decryption module (642), a secure key module (651), a seed key module (652), a random number generator (653), an ISO 0/1 PIN module (654), a MAC/HASH module (655), and a certificate module (656). In other embodiments, the cryptographic module (622) may include additional modules to perform other cryptographic operations. The secure application module (641) can store one or more secure applications and data, such as sets of payment credentials provided according to the invention. The secure application module (641) can process user input selecting a particular function of the secure applications stored therein, and can respond with one or more commands instructing the mobile device (615) to perform certain operations, for example, to send an encrypted communication to carry out the user selected function. The secure application module (641) can also instruct the encryption/decryption module (642) to perform specific cryptographic operations depending on the user selected function.

The encryption/decryption module (642) can store and execute various encryption algorithms such as Advance Encryption Standard (AES), Data Encryption Standard (DES), Triple Data Encryption Standard/Algorithm (TDES/TDEA), Blowfish, Serpent, Twofish, International Data Encryption Algorithm (IDEA), Rivest, Shamir, & Adleman (RSA), Digital Signature Algorithm (DSA), Tiny Encryption Algorithm (TEA), extended TEA (XTEA), and/or other suitable cryptographic or encryption algorithms. In response to encryption and decryption requests from the PPU (630) or from the secure application module (641), the encryption/decryption module (642) can look up the requested encryption algorithm, obtain any necessary keys from other modules in the cryptographic module (622), perform the encryption/decryption request, and respond with the encrypted/decrypted data.

The secure key module (651) stores the set of cryptographic keys (encryption keys and/or decryption keys) that are used in the various encryption algorithms performed by the encryption/decryption module (642). The cryptographic keys can include keys of symmetric key pairs or keys of asymmetric key pairs. The seed key module (652) stores a set of seed keys that are used to initialize the encryption/decryption module (642) in certain encryption algorithms such as AES. The seed key module (652) also stores seed keys that are used by the random number generator (653) to generate random numbers used in certain encryption algorithms such as RSA and DSA. The cryptographic keys stored in the secure key module (651) and/or the seed keys stored in the seed key module (652) are provisioned during manufacturing, and cannot be altered by an external source without a master key that was used during manufacturing to program the cryptographic module (622). The cryptographic keys and seed keys can also be provisioned to be specific to a particular cryptographic expansion device, and hence the cryptographic keys and seed keys can be user-specific and unique to the user of the cryptographic expansion device (600). One advantage of providing user-specific keys is that if the cryptographic keys stored in the cryptographic module (622) are somehow compromised, the infiltration will be isolated to a single user, and the remaining user base of the mobile network will not be compromised. The affected user's keys can be changed without impacting the configuration of the remaining user base.

In some embodiments, the cryptographic module (622) includes an ISO PIN module (654) to mask a user's PIN entry into the mobile device (615) and to generate PIN blocks (e.g., ISO format 0/1 PINs) in accordance with ISO 9564 standard. The PIN blocks generated by the ISO PIN module (654) stores PINs in an encrypted format that are used to verify a user's identity in banking transactions. The encrypted PINs stored in the PIN blocks of the ISO PIN module (654) can be passed from the SPU (620) to the PPU (630) to be included in secure communications sent from the mobile device (615). It should be noted that the PINs stored in the ISO PIN module (654) are never stored in plaintext form, but are instead stored in an encrypted format.

The cryptographic module (622) also includes the Message Authentication Code (MAC)/Hash module (655) to generate and verify MACs and/or hashes for secure communications sent to and from the mobile device (615). A MAC or a hash can be generated for a message or a portion of the message such that the recipient can verify the message's data integrity and authenticity. The cryptographic module (622) can also include a certificate module to provide certificates such as Transport Layer Security (TLS) and Secure Sockets Layer (SSL) certificates used to verify a user's identity in Hypertext Transfer Protocol Secure (HTTPS) applications such as web applications accessed on a web browser of the mobile device (615).

The payment credentials issued to the HSM according to the invention are preferably stored in the secure application module (641) of the cryptographic expansion device, where they are then available to be used by the consumer for subsequent payment transactions. Software provided in the secure application module (641) or on the mobile device is able to access the encrypted payment credentials so that they can be presented to an acceptance terminal when conducting financial transactions. For example, a consumer is able to present the encrypted payment credentials to an acceptance terminal by means of near field communication (NFC) or near sound communication (NSC) between the mobile device and the acceptance terminal. Once the acceptance terminal has received the encrypted payment credentials, the consumer may be prompted to enter a PIN number on the acceptance terminal or the mobile device which, if correct, enables the acceptance terminal to decrypt the payment credentials and process the financial transaction as if a standard EMV card had been presented to the acceptance terminal.

Because the payment credentials are stored in an HSM by means of the secure application module (641), rather than in software, the HSM is able to fulfil the requirements of the PCI standard and allow full track 1 and track 2 data to be stored in the HSM. The provision of the payment credentials can thus be seen as a card-present transaction and enable both point of sale (POS) as well as e-commerce transactions. Issuing payment credentials directly to authorized consumers in the manner described is both significantly cheaper and quicker than physically manufacturing and distributing credit/debit cards. Because multiple sets of payment credentials can be stored in the HSM, consumers do not need to carry multiple cards or devices.

Currently, credit/debit cards expire after a set period which is typically a number of years. To reduce the likelihood of fraud, a much shorter expiry period can be associated with payment credentials provided to the HSM of the mobile device according to the invention. For example, existing payment credentials stored on an HSM of the mobile device can be configured to expire after only a few weeks, or even only a few days, after which new payment credentials can be issued to the HSM. The applicable expiry period can be configured in respect of the risk profile of particular consumers.

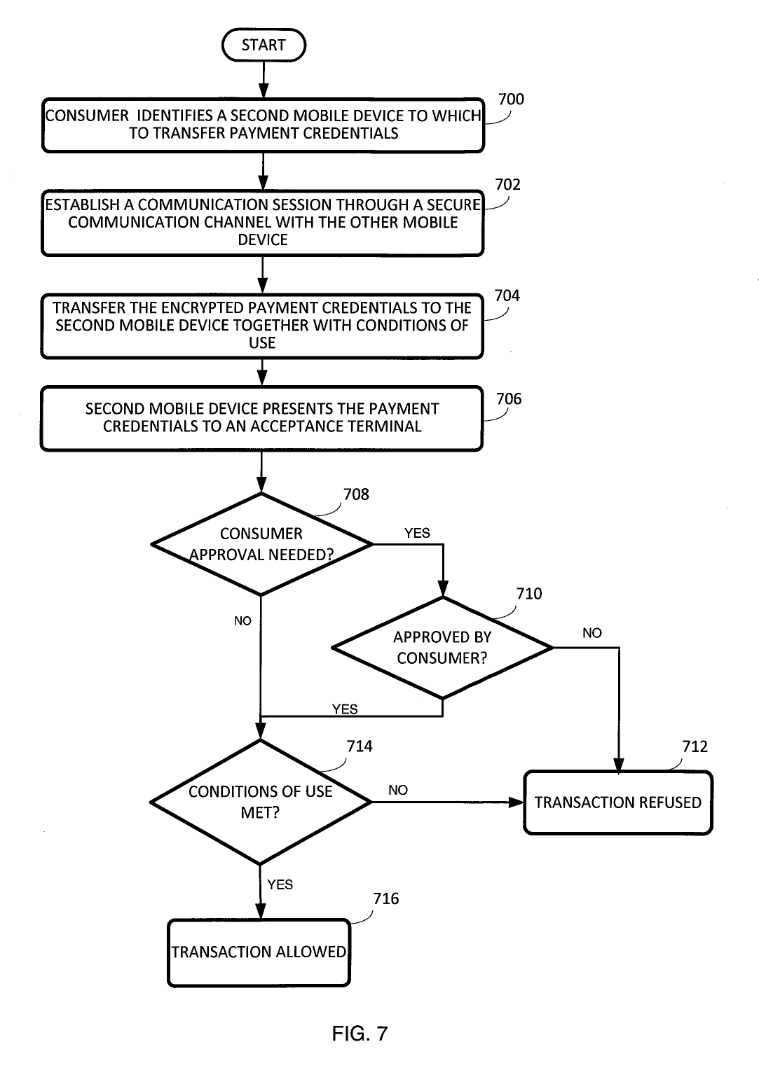

The consumer using a first mobile device is able to authorize the transfer of the payment credentials to a second mobile device that is similar to the consumer mobile device and also includes an HSM, so that a different person is able to use the payment credentials on the consumer's behalf. This is illustrated in FIG. 7. At a first stage (700), the consumer identifies a second mobile device to which to transfer the consumer's payment credentials. This identification may be made by means of the consumer bringing the first mobile device in close proximity with the second mobile device upon which the two devices conduct a secure key exchange handshake process, or by providing some other identifier of the second mobile device to a software application resident on the mobile device which then communicates with the secure gateway.

At a next stage (702), a secure communication channel is then established with the second mobile device in the manner previously described. The communication channel can either be directly between the two mobile devices, or the first mobile device can be configured to cause the secure gateway to establish the secure communication channel with the second mobile device. At a next stage (704), the encrypted payment credentials are then transferred to the second mobile device, either directly from the first mobile device in the case of the secure communication channel being established directly between the two mobile devices, or alternatively by means of the secure gateway sending the encrypted payment credentials to the second mobile device. Together with the encrypted payment credentials, conditions of use can also be transferred to the second mobile device or stored in respect of the second mobile device. Such conditions of use can be pre-set, for example that the payment credentials may only be used once by the second mobile device, or can be selected by the consumer. Examples of conditions of use selected by the consumer may include that the second mobile device only be authorized to conduct transactions up to a certain value, a certain number of times or during a certain time period. These conditions of use will typically be selected by means of a mobile application on the first device. The conditions of use could either be transferred to the second mobile device for use together with the payment credentials, or the conditions of use could be transferred by the consumer to the secure gateway which then transfers the conditions of use to the payment processing network for central storage in association with the payment credentials. In this case, the payment processing network stores the conditions of use in advance of a transaction by the second mobile device.

At a next stage (706), the second mobile device then presents the payment credentials to an acceptance terminal such as a merchant point of sale (POS) device. The transaction is then routed to a payment processing network which is configured to communicate with the secure gateway to determine whether, at a next stage (708), approval of the transaction by the consumer is needed. If approval by the consumer is needed, then at a next stage (710), the transaction is presented to the first mobile device for approval by the consumer. Approval may be in the form of an authorization message presented to the consumer on the first mobile device and which includes information as to the proposed financial transaction to be carried out. If the transaction is not approved by the consumer, then the transaction is refused at a next stage (712).

If the consumer approves the transaction, or if no consumer approval is necessary, the payment processing network then communicates with the secure gateway to determine, at a next stage (714), whether the conditions of use are met, for example whether the amount of the transaction is below a predetermined value, or whether the transaction is within a predetermined number of transactions or a predetermined time window. If the conditions of use are not met, then the transaction is refused at a next stage (712), and if the conditions of use are met, the transaction is allowed at a next stage (716).

Transferring payment credentials as illustrated in FIG. 7 may be desirable, for example, when a manager wishes a subordinate to purchase goods, or a parent wishes a child to pay for certain expenses.

In the case where a manager wishes a subordinate to purchase goods, the manager may wish to impose restrictions on the use of the payment credentials by the subordinate. These restrictions are included in the conditions of use, which are transferred to a mobile device of the subordinate along with the payment credentials or alternatively are transferred to the payment processing network in advance as previously described. For example, the manager may only allow the subordinate to purchase goods from a predefined merchant or from one of a predefined number of merchants.

In the case where a parent is passing payment credentials to a child, the parent may wish to impose restrictions on the use of the payment credentials by the child. For example, the parent may not allow the child to conduct a transaction for an amount higher than a predefined limit.

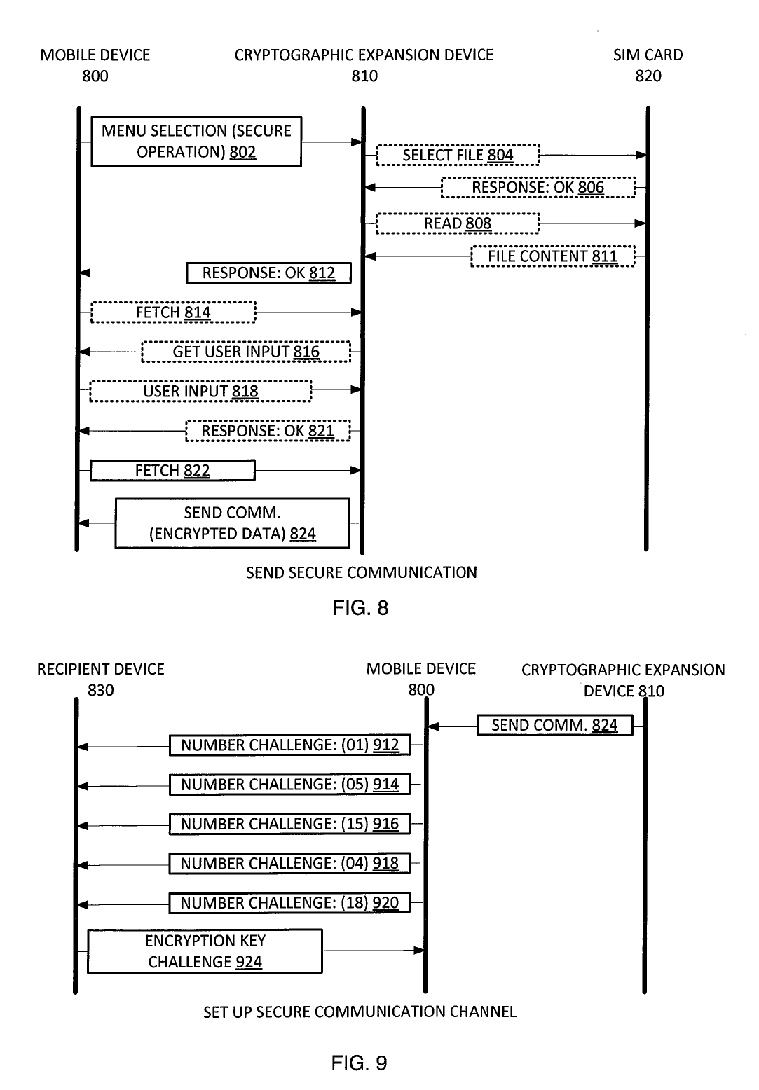

FIG. 8 illustrates a secure communication being sent from a mobile device (800) using the cryptographic expansion device (810) attached to a SIM card (820), according to one embodiment. When a user selects a secure application such as a mobile banking application in the cryptographic expansion device (810) from the user menu of the mobile device (800) to perform a secure operation such as a financial and/or banking transaction, for example, to make a mobile payment or to check an account balance, or to transfer payment credentials to a recipient device, the mobile device (800) sends a menu selection command (802) indicating the secure operation the user wants to perform to the cryptographic expansion device (810). Upon receiving the menu selection command (802), the cryptographic expansion device (810) determines that the menu selection command (802) is requesting a secure application of the cryptographic expansion device (810) to perform a secure operation.

Depending on the secure operation selected by the user, the cryptographic expansion device (810) may optionally retrieve information stored in the cryptographic expansion device (810) such as an encrypted PIN to carry out the secure operation. In some embodiments, certain information stored in the SIM card (820) may also be used to carry out the secure operation. For example, the secure operation may include sending a secure communication from the mobile device (800) to a recipient device, and the unique serial number (ICCID) of the SIM card (820) and/or the international mobile subscriber identity (IMSI) of the SIM card (820) may be included in the secure communication to verify the identity of the cryptographic expansion device (810). In such embodiments, the cryptographic expansion device (810) may optionally send a select file command (804) to the SIM card (820) to access the designated file storing the information in the SIM card (820). In response to receiving the select file command (804), the SIM card (820) sends a response (806) to the cryptographic expansion device (810) indicating the designated file has been selected and is ready to be read. The cryptographic expansion device (810) then sends a read command (808) to the SIM card (820) to read the information from the designated file. In response to the read command (808), the SIM card (820) sends file content (811), for example, the ICCID and/or IMSI of the SIM card (820), to the cryptographic expansion device (810).

Next, the cryptographic expansion device (810) sends a response (812) to the mobile device (800) to acknowledge that the menu selection command (802) was received. The mobile device (800) then sends a fetch command (814) to the cryptographic expansion device (810) to obtain any pending commands that the cryptographic expansion device (810) wants the mobile device (800) to perform to carry out the secure operation. In some embodiments, depending on the secure operation selected by the user, in response to receiving the fetch command (814), the cryptographic expansion device (810) may optionally send a display command (not shown) to the mobile device (800) to instruct the mobile device (800) to prompt a user for input on the display screen of mobile device, for example, to prompt the user to enter a PIN, account information, payment recipient information, or other information related to the secure operation being performed. When the user enters the requested information on the user interface of the mobile device (800), the mobile device (800) sends a user-input-event command (not shown) to the cryptographic expansion device (810) to notify the cryptographic expansion device (810) that user input has been received. The cryptographic expansion device (810) can then send a get-user-input command (816) to the mobile device (800) to request the user input. In response, the mobile device (800) sends user input (818) to the cryptographic expansion device (810). The cryptographic expansion device (810) may perform cryptographic operations on the user input such as encrypting the user input using any of the encryption algorithms stored in the cryptographic expansion device (810), or generate a MAC or hash of the user input. The cryptographic expansion device (810) sends a response (821) to the mobile device (800) acknowledging the user input has been received.

The mobile device (800) may send another fetch command (not shown) to the cryptographic expansion device (810) to obtain further device commands that the cryptographic expansion device (810) wants the mobile device (800) to execute to carry out the secure operation. Thus, the mobile device (800) and the cryptographic expansion device (810) can optionally exchange a series of fetch commands and device commands in response to those fetch commands to instruct the mobile device (800) to perform various functions to carry out the secure operation selected by the user. Furthermore, depending on the secure operation selected by the user, the information that the cryptographic expansion device (810) may request or use to carry out the secure operation is not just limited to user input. For example, the cryptographic expansion device (810) may send commands to the mobile device (800) to instruct the mobile device (800) to retrieve information using any of the interfaces of the mobile device (800). The cryptographic expansion device (810) may instruct the mobile device (800) to obtain location information from a global positioning system interface of the mobile device (800). The cryptographic expansion device (810) may request information received from a NFC device or NSC device through a NFC or NSC interface of the mobile device (800). The cryptographic expansion device (810) may instruct the mobile device (800) to retrieve information from the Internet through a wireless data interface of the mobile device (800), and so on. The cryptographic expansion device (810) may perform additional cryptographic operations on any information obtained from the various interfaces of the mobile device (800).

Once the cryptographic expansion device (810) has obtained and performed the desired cryptographic operations on the information (e.g., payment credentials, account numbers, transaction amount, etc.) that the cryptographic expansion device (810) will use to carry out the secure operation, in response to a fetch command (822) received from the mobile device (800), the cryptographic expansion device (810) can transmit a send communication command (824) with an encrypted message that includes information such as the information described above to the mobile device (800). The send communication command (824) can instruct the mobile device (800) to transmit an encrypted message provided by the cryptographic expansion device (810) using any of the communication interfaces available on the mobile device (800). For example, the send communication command (824) may instruct the mobile device (800) to send a secure SMS message with encrypted data provided by the cryptographic expansion device (810) to a server to make a mobile payment or to check account balance, or to send a secure SMS message with encrypted payment credentials to a second mobile device having an HSM. The send communication command (824) may instruct the mobile device (800) to send a secure USSD message with encrypted data to start a USSD two-way communication session with a banking server. The send communication command (824) may also instruct the mobile device (800) to send a secure NFC, NSC or RF communication with encrypted data via the NFC, NSC or RF interface of the mobile device (800) to a NFC, NSC or RF enabled recipient device such as a point-of-sale (POS) terminal or a second mobile device having an HSM.

Because the information that the mobile device (800) transmits out in the secure communication is provided to the mobile device (800) in an encrypted format by the cryptographic expansion device (810), the secure communication is already encrypted when it leaves the communication interface of the mobile device (800). In this manner, secure encrypted end-to-end communication can be maintained between the mobile device (800) and a recipient device.

Referring now to FIG. 9, in some embodiments, the send communication command (824) may instruct the mobile device (800) to send a series of messages to a recipient device (830) to set up a secure communication channel or tunnel. Alternatively, a secure gateway may send such messages to the mobile device (800) itself to set up a secure communication channel, in other words, the mobile device (800) may be the recipient device in some cases. In the case where a secure channel is set up between the mobile device (800) and the recipient device (830), the series of messages (912-920) can be used to verify the identity of recipient device (830) and to verify the identity of the mobile device (800) to recipient device (830). This way of verifying the identities of the communicating devices can be especially useful with NFC, NSC and/or RF communications where the identity of the recipient device (830) may not be known to the mobile device (800) prior to the communication. The series of messages (912-920) can be a number challenge that includes a specific sequence of numbers that is only known to the mobile device (800) as provided by the cryptographic expansion device (810), and only known to authorized recipient devices that are allowed to communicate with the mobile device (800).

When the recipient device (830) receives a first message (912), the recipient device (830) does not initially respond. The recipient device (830) will not respond until all messages (912-920) has been received and the number sequence transmitted in the messages (912-920) is confirmed to be a valid and correct sequence. Thus, the recipient device (830) can verify the identity of the mobile device (800) based on the number challenge received in the series of messages (912-920). The mobile device (800) can also use the number challenge to verify the identity of recipient device (830). For example, if a recipient device responds to the first message (912), the mobile device (800) can determine that the recipient device is not an authorized recipient device because an authorized recipient device would not respond right away to the first message (912). It should be appreciated that the series of messages as described is not limited to five messages as shown, and can include any number of messages, and that the number challenge can be any sequence of numbers, sequence of alphanumeric characters, or sequence of other types of messages. Furthermore, in other embodiments, the mobile device (800) equipped with the cryptographic expansion device (810) can act as a recipient device and be on the receiving end of a number challenge, as mentioned above.

In some embodiments, to provide an additional level of security to verify the identity of the devices, the recipient device (830) can respond to the reception of a valid and correct number challenge with an encryption key challenge (924). The encryption key challenge (924) can be a symmetric key challenge or an asymmetric key challenge. In the encryption key challenge (924), the recipient device (830) can send a random number to the mobile device (800) to request the mobile device (800) to encrypt the random number with an encryption key that would only be known to an authorized device. The mobile device (800) can send the random number to the cryptographic expansion device (810) and request the cryptographic expansion device (810) to encrypt the random number using the requested encryption key stored in the cryptographic expansion device (810). The cryptographic expansion device (810) can respond to the mobile device (800) with the encrypted random number, and the mobile device (800) then sends the encrypted random number to the recipient device (830). The recipient device (830) then decrypts the encrypted random number with a corresponding key, which can be a symmetric key or an asymmetric key. If the decryption results in the random number that the recipient device (830) has previously sent to the mobile device (800), then the recipient device (830) can be further assured that the mobile device (800) equipped with the cryptographic expansion device (810) is an authorized device, and a secure communication channel or tunnel can be established between the mobile device (800) and the recipient device (830). Exchange of sensitive information with secure communications between the two devices can then proceed.

One advantage of being able to verify the identities of the communicating devices using the cryptographic expansion device (810) as described above is that the number sequence of the number challenge and the encryption key used in the encryption key challenge can be provisioned to be unique for each cryptographic expansion device, and thus can be provisioned to be user specific. If the number sequence and/or the encryption key used in the encryption key challenge is somehow compromised, the infiltration will be isolated to a single user, and the remaining user base of the mobile network will not be compromised. The affected user's keys can be changed without impacting the configuration of the remaining user base.

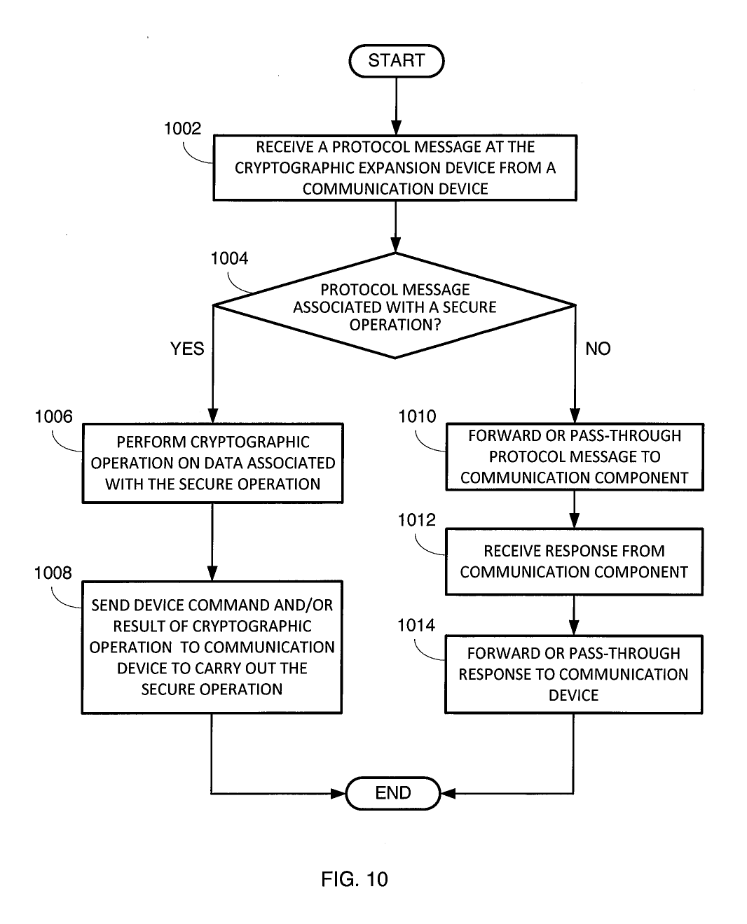

FIG. 10 illustrates a flow diagram for enabling transmission of secure communications from a communication device (e.g., the mobile device (800) of FIG. 8) using a cryptographic expansion device (e.g., the cryptographic expansion device (810) of FIG. 8) attached to a communication component (e.g., the SIM card (820) of FIG. 8) of the communication device, according to various embodiments. These communications may include payment credentials which are to be transferred from a consumer mobile device to a second mobile device.

At a first stage (1002), the cryptographic expansion device receives a protocol message from the communication device according to a communication protocol that the communication device uses to communicate with the communication component. The protocol message can be a command or information that is associated with a secure operation to be performed by the cryptographic expansion device. For example, the protocol message can be a command associated with a request from a user to perform a financial or banking transaction using a secure application stored in the cryptographic expansion device such as a mobile banking application or a contactless payment application. The financial or banking transaction can be a mobile payment, a mobile money transfer, an account balance inquiry, or other financial or banking transactions or account inquiries, and may involve sending or receiving a secure communication. The request may also be a request from a user to transmit payment credentials to a second mobile device. The protocol message can be a command or information associated with a non-secure operation that is intended for the communication component of the communication device. In some embodiments, the protocol message can include a flag or a protocol identification (ID) field to indicate whether the protocol message is intended for the communication component.

At a next stage (1004), the cryptographic expansion device determines if the protocol message is associated with a secure operation. If the cryptographic expansion device determines that the protocol message involves a secure operation to be performed by the cryptographic expansion device, for example, by examining the flag or the protocol ID of the protocol message, then at a next stage (1006), using the embedded cryptographic processor, the cryptographic expansion device processes the protocol message and performs a cryptographic operation on data or information associated with the secure operation as indicated by the protocol message. The data or information can be data or information that is stored in the cryptographic expansion device, such as payment credentials, and/or in the communication component, or data or information such as user input or other information that is obtained from an interface of the communication device.

For example, to carry out a secure operation such as sending a secure communication to perform a financial or banking transaction, the cryptographic expansion device may retrieve an encrypted PIN from the cryptographic expansion device, obtain subscriber information from the communication component, and/or obtain user input from the communication device such as a PAN or a portion of a PAN entered by a user on the user interface of the communication device. To transfer payment credentials, the cryptographic expansion device may retrieve, or encrypt and retrieve, the encrypted payment credentials from the cryptographic expansion device, for example, from the secure application module or the secure memory of the cryptographic expansion device. The data or information associated with the secure operation can also be embedded in the protocol message received from the communication device. For example, the protocol message received from the communication device can include an encrypted communication for the cryptographic expansion device to decrypt.

To perform the cryptographic operation on data or information associated with the secure operation, the cryptographic expansion device may select a suitable encryption and/or MAC or hash algorithm stored in the cryptographic expansion device. The cryptographic expansion device then retrieves a cryptographic or encryption key associated with the selected encryption, and performs a cryptographic operation such as encrypting or decrypting the data or information associated with the secure operation using the encryption key and selected algorithm. The cryptographic expansion device may also generate or verify a MAC or hash on data or information associated with the secure operation.

Then at a next stage (1008), the cryptographic expansion device sends a device command and/or the result of the cryptographic operation (i.e. processed data such as encrypted or decrypted data) to the communication device in accordance with the protocol of the protocol message. The processed data or device command can be sent from the cryptographic expansion device to the communication device, for example, via the first set of electrical contacts of the cryptographic expansion device. The device command can include commands instructing the communication device to perform certain operations to carry out the secure operation such as sending encrypted data provided by the cryptographic expansion device in a secure communication on a communication interface of the communication device. In some embodiments, the communication interface can be a cellular interface for sending SMS or USSD messages, or a NFC, NSC or RF interface for sending NFC, NSC or RF communications. In other embodiments, the communication interface can be any of the communication interfaces provided in the communication device. In the case of payment credentials, any of these interfaces may then be used to transmit the payment credentials to a second mobile device.

As another example, the device command can instruct the communication device to display plaintext data or information to a user that the cryptographic expansion device decrypted from an encrypted message sent to the communication device. It should be understood that depending on the secure operation that is being requested or associated with the protocol message received from the communication device at the initial stage (1002), the cryptographic expansion device may send more than one device command to the communication device to carry out the secure operation, and that in some embodiments, there can be multiple iterations of protocol message and device command exchanges to carry out a secure operation.

Referring back to the second stage (1004), if the cryptographic expansion device determines that the protocol message is associated with a non-secure operation that is intended for the communication component, then at a next stage (1010), the cryptographic expansion device forwards or passes through the protocol message to the communication component. At a further stage (1012), the communication component may reply to the cryptographic expansion device with a response to the protocol message. Upon receiving the response to the protocol message from the communication component, at a next stage (1014), the cryptographic expansion device forwards or passes through the response to the communication device.

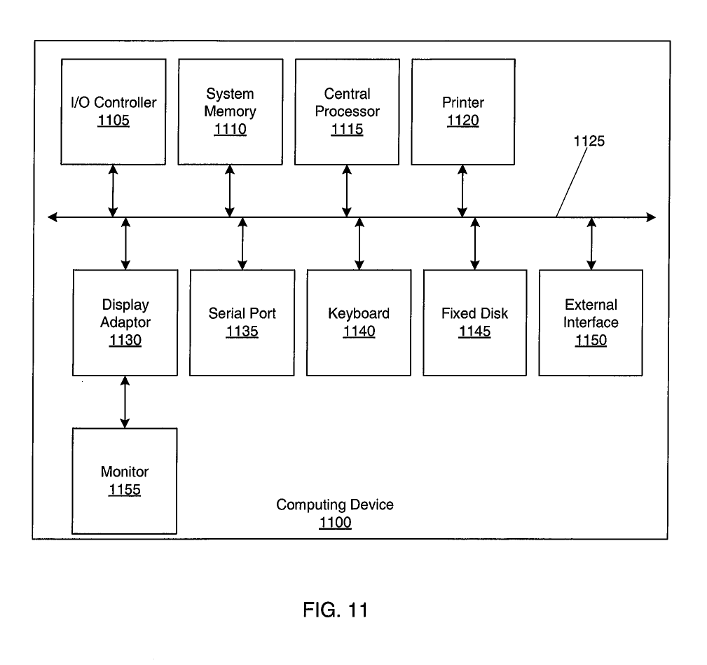

FIG. 11 illustrates an example of a computing device (1100) in which various aspects of the disclosure may be implemented. The various participants and elements in the previously described system diagrams may use any suitable number of subsystems in the computing device (1100) to facilitate the functions described herein. Examples of such subsystems or components are shown in FIG. 11. The subsystems shown in FIG. 11 are interconnected via a system bus (1125).

Additional subsystems such as a printer (1120), a keyboard (1140), a fixed disk (1145) (or other memory comprising computer-readable media), a monitor (1155), which is coupled to a display adapter (1130), and others are shown. Peripherals and input/output (I/O) devices (not shown), which couple to an I/O controller (1105), can be connected to the computing device (1100) by any number of means known in the art, such as a serial port (1135). For example, the serial port (1135) or an external interface (1150) can be used to connect the computing device (1100) to a wide area network such as the Internet, a mouse input device, or a scanner. The interconnection via the system bus (1125) allows a central processor (1115) to communicate with each subsystem and to control the execution of instructions from system memory (1110) or the fixed disk (1145), as well as the exchange of information between subsystems. System memory (1110) and/or the fixed disk (1145) may embody a computer-readable medium.

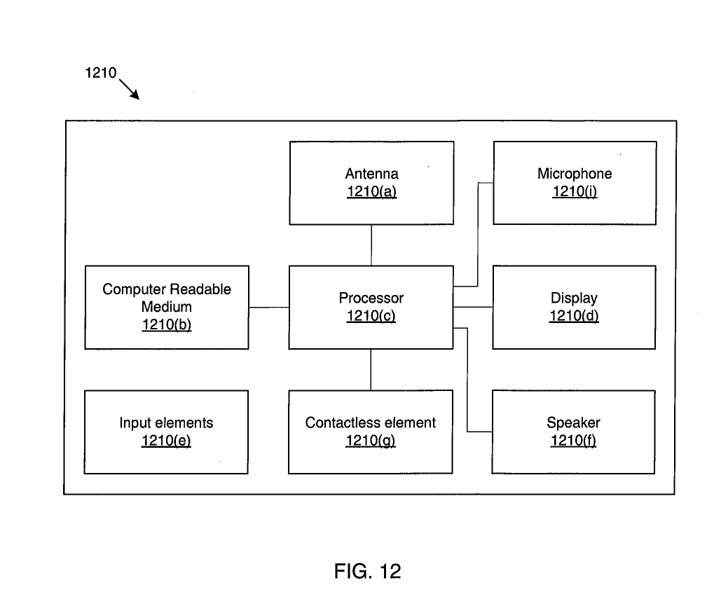

FIG. 12 shows a block diagram of a mobile phone (1210) that can be used in embodiments of the invention. The phone can be a notification device that can receive alert messages and access reports, a portable merchant device that can be used to transmit control data identifying a discount to be applied, as well as a portable consumer device that can be used to make payments. The exemplary phone (1210) may comprise a computer readable medium and a body as shown in FIG. 12. A computer readable medium (1210(b)) may be in the form of (or may be included in) a memory that stores data (e.g., issuer account numbers, loyalty provider account numbers, etc.). The memory may store control data identifying a discount to be applied. The memory may also store information such as financial information, transit information (e.g., as in a subway or train pass), access information (e.g., as in access badges), etc. Financial information may include information such as bank account information, loyalty account information (e.g., a loyalty account number), a bank identification number (BIN), credit or debit card number information, account balance information, expiration date, consumer information such as name, date of birth, etc. Any of this information may be transmitted by the phone (1210).

The phone (1210) may further include a contactless element (1210(g)), which is typically implemented in the form of a semiconductor chip (or other data storage element) with an associated wireless transfer (e.g., data transmission) element, such as an antenna. The contactless element (1210(g)) may be associated with (e.g., embedded within) the phone (1210) and data or control instructions transmitted via a cellular network may be applied to the contactless element (1210(g)) by means of a contactless element interface (not shown). The contactless element interface may function to permit the exchange of data and/or control instructions between the mobile device circuitry (and hence the cellular network) and an optional contactless element (1210(g)).

The contactless element (1210(g)) may be capable of transferring and receiving data using a near field communications (NFC) capability (or near field communications medium) typically in accordance with a standardized protocol or data transfer mechanism (e.g., ISO 14443/NFC), or a NSC capability or communications medium. Near field communications capability is a short-range communications capability, such as RFID, Bluetooth, infra-red, or other data transfer capability that can be used to exchange data between the phone (1210) and an interrogation device. Thus, the phone (1210) may be capable of communicating and transferring data and/or control instructions via both a cellular network and near field communications capability.

The phone (1210) may also include a processor (1210(c)) (e.g., a microprocessor) for processing the functions of the phone (1210) and a display (1210(d)) to allow a consumer to see the phone numbers and other information and messages. The phone (1210) may further include input elements (1210(e)) to allow a user to input information into the device, a speaker (1210(f)) to allow the user to hear voice communication, music, etc., and a microphone (1210(i)) to allow the user to transmit his or her voice through the phone (1210). The phone (1210) may also include an antenna (1210(a)) for wireless data transfer (e.g., data transmission).

A system and method for issuing payment credentials to a mobile phone of a consumer is therefore provided. By issuing payment credentials directly to an HSM of a mobile device, such as the cryptographic expansion device in accordance with the embodiments described, an instance of a traditional debit or credit card is created on the HSM. Therefore, full track 1 and track 2 data may be stored on the HSM. It may also be possible, as described above, to store multiple sets of payment credentials each associated with a financial account in order to create a mobile wallet.

If these payment credentials are then provisioned to, for example, an acceptance terminal or e-commerce system for performing a financial transaction, the transaction may be carried out as a card-present transaction, in other words, as if a standard EMV card had been presented. Furthermore, it may be significantly cheaper and less cumbersome to issue payment credentials directly to a consumer's mobile device as opposed to manufacturing and distributing physical debit or credit cards.

Additionally, the ability to transfer encrypted payment credentials to recipient devices and/or acceptance terminals may reduce the need to present or transmit payment credentials “in the clear”, which may subsequently reduce the risk of fraudulent activities such as man-in-the-middle attacks.

Allowing a consumer to authorize the transfer of payment credentials to a second mobile device that also includes an HSM, so that a different person is able to use the payment credentials on behalf of the consumer, may increase convenience and/or security, because these credentials may be transferred using secure communications instead of transmitting them in the clear. Furthermore, the consumer may be notified of or required to authorize proposed transactions using the payment credentials transmitted to other mobile devices with specific conditions for use.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method of issuing payment credentials to a consumer, the method comprising the steps of:
at a secure gateway, receiving payment credentials and a consumer identifier of a specific consumer to whom the payment credentials belong;
encrypting or zone-translating the payment credentials;
communicating through a secure communication channel with a mobile device of the specific consumer to whom the payment credentials belong, the mobile device having a hardware security module (HSM) and the mobile device being identified by the consumer identifier; and
forwarding the encrypted payment credentials through the secure communication channel to the mobile device, wherein the mobile device stores the encrypted payment credentials on the HSM of the mobile device, and
wherein the mobile device is configured to enable the consumer to authorize the transfer of the payment credentials to a second mobile device, so that a different person is able to use the payment credentials on behalf of the consumer.

2. The method of claim 1, wherein the step of communicating through a secure communication channel with the mobile device of the specific consumer to whom the payment credentials belong includes the step of matching the consumer identifier with a stored identifier of the HSM of the mobile device.

3. The method of claim 1, wherein the secure communication channel is established with the mobile device using a predetermined sequence of network messages that are received at the HSM.

4. The method of claim 1, wherein the secure communication channel is established by the secure gateway presenting the mobile device with a cryptographic key challenge.

5. (canceled)

6. The method of claim 1, wherein the mobile device is configured to store multiple sets of payment credentials on the HSM, corresponding to multiple payment accounts belonging to the consumer.

7. The method of claim 1, wherein the payment credentials include full payment credentials necessary to establish a card-present type transaction.

8. (canceled)

9. The method of claim 1, wherein the payment credentials are transferred to the second mobile device using secure communications through a secure communication channel directly between the mobile device of the consumer and the second mobile device.

10. The method of claim 1, wherein the payment credentials are transferred to the second mobile device via the secure gateway using secure communications through a secure communication channel between the secure gateway and the second mobile device.

11. The method of claim 1, wherein conditions of use are transferred to the second mobile device or to the secure gateway for central storage thereof in association with the payment credentials, the conditions of use associated with restrictions on use of the payment credentials by a user of the second mobile device.

12.-13. (canceled)

14. The method of claim 1, wherein the HSM is a cryptographic expansion device attached to a communication component of the mobile device.

15. The method of claim 14, wherein the communication component is a SIM card, and the cryptographic expansion device is in the form of a label that is attached to the SIM card.

16.-17. (canceled)

18. A system for issuing payment credentials to a consumer, the system comprising:
a secure gateway;
wherein the secure gateway is configured to:
receive payment credentials and a consumer identifier of the specific consumer to whom the payment credentials belong, the consumer having a mobile device with a hardware security module (HSM) and the mobile device being identified by the consumer identifier;
encrypt or zone-translate the payment credentials;
communicate through a secure communication channel with the mobile device of the specific consumer to whom the payment credentials belong; and
forward the encrypted payment credentials through the secure communication channel to the mobile device, wherein the mobile device stores the encrypted payment credentials on the HSM of the mobile device and
wherein the mobile device is configured to enable the consumer to authorize the transfer of the payment credentials to a second mobile device, so that a different person is able to use the payment credentials on behalf of the consumer.

19. (canceled)

20. A method of transferring payment credentials stored in a hardware security module (HSM) of a first mobile device to a second mobile device, the method comprising the steps of:
establishing a secure communications channel between the first mobile device and the second mobile device; and
transferring the payment credentials from the first mobile device to the second mobile device in an encrypted format through the secure communications channel.

21. The method of claim 20, wherein the second mobile device has an HSM in which the payment credentials are stored after the payment credentials are transferred from the first mobile device to the second mobile device.

22. The method of claim 20, wherein the step of transferring the payment credentials from the first mobile device to the second mobile device in an encrypted format through the secure communications channel includes the step of transferring conditions of use to the second mobile device or to a secure gateway for central storage thereof in association with the payment credentials, the conditions of use associated with restrictions on use of the payment credentials by a user of the second mobile device.

23. The method of claim 20, wherein conditions of use are transferred to the secure gateway for central storage thereof in association with the payment credentials, the conditions of use associated with restrictions on use of the payment credentials by a user of the second mobile device.

24. The method of claim 1, wherein the second mobile device has an HSM in which the payment credentials are stored after the payment credentials are transferred from the mobile device of the consumer to the second mobile device.

25. The method of claim 9, wherein the secure communication channel is generated using a series of messages transmitted between the mobile device of the consumer and the second mobile device, the messages being used by the mobile device of the consumer to verify the identity of second mobile device and by the second mobile device to verify the identity of the mobile device of the consumer.

26. The method of claim 1, wherein the secure gateway is configured to, subsequent to the second mobile device presenting the payment credentials to an acceptance terminal, determine whether approval of the transaction by the consumer is needed, and, if approval by the consumer is needed, present the transaction to the first mobile device for approval by the consumer.

27. The method of claim 20, wherein a secure gateway is configured to, subsequent to the second mobile device presenting the payment credentials to an acceptance terminal, determine whether approval of the transaction by a consumer associated with the first mobile device is needed, and, if approval by the consumer is needed, present the transaction to the first mobile device for approval by the consumer.

28. The method of claim 20, wherein the secure communications channel is generated using a series of messages transmitted between the first mobile device and the second mobile device, the messages being used by the first mobile device to verify the identity of second mobile device and by the second mobile device to verify the identity of the first mobile device.
